(19) United States
(12) Patent Application Publication
(10) Pub. No.: US 2022/0100933 A1
(43) Pub. Date: Mar. 31, 2022

(54) Mesoscopic simulation method for liquid-vapor phase transition

(71) Applicant: Central South University, Changsha (CN)

(72) Inventors: Rongzong HUANG, Changsha (CN); Lijuan LAN, Changsha (CN)

(21) Appl. No.: 17/409,829

(22) Filed: Aug. 24, 2021

Related U.S. Application Data
(63) Continuation of application No. PCT/CN2020/118804, filed on Sep. 29, 2020.

(30) Foreign Application Priority Data
Sep. 29, 2020 (CN) 2020110455009

(51) Int. Cl. G06F 30/28

(52) U.S. Cl. CPC G06F 30/28; G06F 2111/10

(57) ABSTRACT

A mesoscopic simulation method for liquid-vapor phase transition: Short-range repulsive intermolecular interaction is incorporated by equation of state for dense gas, long-range attractive intermolecular interaction is mimicked by pairwise interaction force, density distribution function is used to handle mass-momentum conservation laws, and total kinetic energy distribution function is used to handle energy conservation law. Lattice Boltzmann equation for density distribution function recovers the equation of state for dense gas and pairwise interaction force. Lattice Boltzmann equation for total kinetic energy distribution function recovers viscous dissipation, compression work, and works done by the pairwise interaction force and surface tension. The method has microscopic particle picture, mesoscopic kinetic background, conceptual and computational simplicity, wide applicability, and high reliability. The method is kinetically and thermodynamically consistent and allows direct numerical simulations of liquid-vapor phase transition processes.

### BACKGROUND

Liquid-vapor phase transition is a fundamental thermophysical phenomenon that widely exists in natural and engineering systems. There is a phase interface between the liquid and vapor phases in the phase transition process, and the location of the phase interface is unknown in advance and evolves dynamically over time. In the phase interface, the phase transition occurs accompanied by the release or absorption of a large amount of latent heat. The liquid and vapor phases usually have a large density contrast, and their physical properties like the dynamic viscosity and heat conductivity are also significantly different. Liquid-vapor phase transition is extremely complicated at the macroscopic level, such as nucleating, overheating, supersaturating, evaporating, boiling, condensing, etc. All the above characteristics make the simulation of liquid-vapor phase transition extremely challenging. The existing macroscopic numerical method relies on complex interface capturing or tracking techniques and also uses many phenomenological assumptions, approximations, and/or simplifications in modeling liquid-vapor phase transition. The macroscopic numerical method cannot directly reflect the underlying realistic physics responsible for liquid-vapor phase transition, and thus both the applicability of the method and the reliability of the result cannot be guaranteed in advance.

Although liquid-vapor phase transition is extremely complicated at the macroscopic level, the corresponding underlying microscopic physics is quite simple. Physically speaking, liquid-vapor phase transition and the associated dynamics are the natural consequences of the microscopic intermolecular interaction. The microscopic intermolecular interaction generally consists of a short-range repulsive part and a long-range attractive part, wherein the short-range repulsive part arises from the finite molecular size and can be modeled by Enskog theory for dense gases, while the long-range attractive part can be regarded as a local point force using mean-field theory. Therefore, numerical modeling of liquid-vapor phase transition from the physical viewpoint of microscopic intermolecular interaction has the distinct advantages of clear concept and simple computation and can reflect the physical nature of the phase transition process. As a mesoscopic method of computational fluid dynamics, the lattice Boltzmann method originates from the lattice gas automata and can also be viewed as a special discrete form of the Boltzmann equation. The lattice Boltzmann method combines the microscopic particle basis and the kinetic theory background. This method can incorporate the microscopic intermolecular interaction and is particularly suitable for numerical modeling and simulation of liquid-vapor phase transition.

### SUMMARY

Within the theoretical framework of lattice Boltzmann method, a mesoscopic simulation method for liquid-vapor phase transition is provided. Physically speaking, this mesoscopic simulation method uses an equation of state for dense gases to incorporate short-range repulsive intermolecular interaction and uses a pairwise interaction force to mimic long-range attractive intermolecular interaction. Numerically speaking, this mesoscopic simulation method solves mass-momentum conservation laws by density distribution function and solves energy conservation law by total kinetic energy distribution function. This mesoscopic simulation method comprises the following steps:
S1. Choosing the equation of state for real gases and corresponding parameters, setting the initial temperature, determining the saturated liquid and vapor densities, setting the surface tension and interface thickness;
S2. Setting the lattice spacing and lattice sizes, computing the interaction strength, lattice sound speed, time step, and constant-volume specific heat;
S3. Initializing the density, velocity, total kinetic energy, temperature, and pressure on the lattice nodes, computing the pairwise interaction force based on the density field, initializing the density and total kinetic energy distribution functions;
S4. Performing the local collision process of the lattice Boltzmann equation for density distribution function and then getting the post-collision density distribution function, performing the local collision process of the lattice Boltzmann equation for total kinetic energy distribution function and then getting the post-collision total kinetic energy distribution function;
S5. Performing the linear streaming process of the lattice Boltzmann equation for density distribution function and then getting the density distribution function at the next time step, performing the linear streaming process of the lattice Boltzmann equation for total kinetic energy distribution function and then getting the total kinetic energy distribution function at the next time step;
S6. Computing the density at the next time step, updating the pairwise interaction force based on the density field, computing the velocity, total kinetic energy, temperature, and pressure at the next time step;
S7. Determining the density, velocity, total kinetic energy, temperature, and pressure on the boundary lattice nodes based on specified boundary conditions, constructing the density and total kinetic energy distribution functions on the boundary lattice nodes via the treatment scheme of boundary condition for the lattice Boltzmann method;
S8. Repeating Steps S4-S7 until the end of liquid-vapor phase transition or a specified time.

The total kinetic energy in the mesoscopic simulation method is thermodynamically defined as: The total kinetic energy ρeₖ is the sum of the internal kinetic energy ρòₖ and the macroscopic kinetic energy ½ρ|u|², i.e., ρeₖ=ρòₖ+½ρ|u|². The internal kinetic energy ρòₖ and the internal potential energy ρòₖ together constitute the internal energy ρòₖ i.e., ρò=ρòₖ+ρòₚ. The internal energy ρò and the macroscopic kinetic energy ½ρ|u|² together constitute the total energy ρe, i.e., ρe=ρò+½ρ|u|². Here, ρ is the density, u is the velocity, eₖ is the specific total kinetic energy, òₖ is the specific internal kinetic energy, òₚ is the specific internal potential energy, ò is the specific internal energy, and e is the specific total energy.

The total kinetic energy in the mesoscopic simulation method is interpreted at the mesoscopic level as: The physical interpretations at the mesoscopic level of the density ρ, velocity u, internal kinetic energy ρòₖ, and total kinetic energy ρeₖ are ρ=òƒ(x,ξ,t)dξ, ρu=òƒ(x,ξ,t)ξdξ,

$${ρò}_{k} = ò f ( x , ξ , t ) \frac{{\vert ξ - u \vert}^{2}}{2} dξ , and ρ {e}_{k} = ò f ( x , ξ , t ) \frac{{\vert ξ \vert}^{2}}{2} d ξ ,$$

respectively. Here, ƒ(x,ξ,t) is the continuum density distribution function described by the Boltzmann equation in kinetic theory, ξ is the molecular velocity, x is the position, and t is the time.

The internal kinetic energy in the mesoscopic simulation method satisfies: The internal kinetic energy ρòₖ relates to the temperature T by ρòₖ=ρcᵥT with cᵥ being the constant-volume specific heat.

The underlying physics of the internal potential energy in the mesoscopic simulation method is: The internal potential energy ρòₚ is the energy possessed by a molecule due to long-range attractive interaction from the other molecules.

The treatment method of the internal potential energy in the mesoscopic simulation method is: The transport process of the internal potential energy ρòₚ is represented by mimicking the work done by the long-range attractive intermolecular interaction.

The calculation method of the density, velocity, total kinetic energy, temperature, and pressure in the mesoscopic simulation method is: The density ρ and velocity u are calculated by the density distribution function, the total kinetic energy ρeₖ is calculated by the total kinetic energy distribution function, and the temperature and pressure are uniquely determined by ρ, u, and ρeₖ according to the thermodynamic relations.

The evolution equation in the mesoscopic simulation method satisfies: The lattice Boltzmann equation for density distribution function recovers the equation of state for dense gas and pairwise interaction force.

The evolution equation in the mesoscopic simulation method satisfies: The lattice Boltzmann equation for total kinetic energy distribution function recovers viscous dissipation, compression work, and works done by the pairwise interaction force and surface tension.

The mesoscopic simulation method has microscopic particle picture, mesoscopic kinetic background, conceptual and computational simplicity, wide applicability, and high reliability. The mesoscopic simulation method is kinetically and thermodynamically consistent and allows direct numerical simulations of liquid-vapor phase transition processes.

### BRIEF DESCRIPTION OF THE FIGURES

FIG. 1 is the flowchart of the mesoscopic simulation method for liquid-vapor phase transition.

FIG. 2 is the illustration of the droplet evaporation in two-dimensional space.

FIG. 3 is the evolution of the square of the normalized droplet diameter with the normalized time, together with four snapshots of the local density and temperature fields, in the droplet evaporation process in two-dimensional space.

### DESCRIPTION

To make the mesoscopic simulation method for liquid-vapor phase transition clearer, it is further described according to the mode of carrying out the method and in conjunction with the specific embodiment and figures.

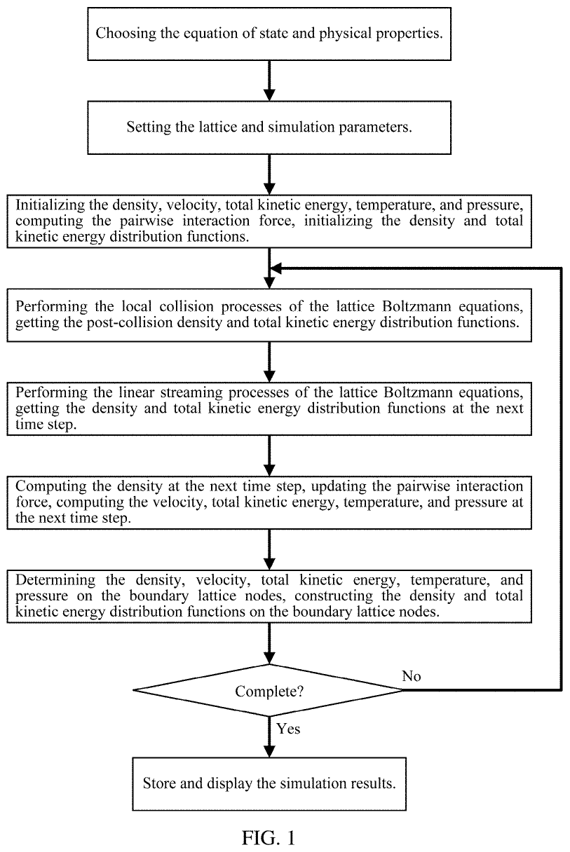

As shown in FIG. 1, the mesoscopic simulation method for liquid-vapor phase transition comprises the following steps:
S1. Choosing the equation of state for real gases and corresponding parameters, setting the initial temperature, determining the saturated liquid and vapor densities, setting the surface tension and interface thickness;
S2. Setting the lattice spacing and lattice sizes, computing the interaction strength, lattice sound speed, time step, and constant-volume specific heat;
S3. Initializing the density, velocity, total kinetic energy, temperature, and pressure on the lattice nodes, computing the pairwise interaction force based on the density field, initializing the density and total kinetic energy distribution functions;
S4. Performing the local collision process of the lattice Boltzmann equation for density distribution function and then getting the post-collision density distribution function, performing the local collision process of the lattice Boltzmann equation for total kinetic energy distribution function and then getting the post-collision total kinetic energy distribution function;
S5. Performing the linear streaming process of the lattice Boltzmann equation for density distribution function and then getting the density distribution function at the next time step, performing the linear streaming process of the lattice Boltzmann equation for total kinetic energy distribution function and then getting the total kinetic energy distribution function at the next time step;
S6. Computing the density at the next time step, updating the pairwise interaction force based on the density field, computing the velocity, total kinetic energy, temperature, and pressure at the next time step;
S7. Determining the density, velocity, total kinetic energy, temperature, and pressure on the boundary lattice nodes based on specified boundary conditions, constructing the density and total kinetic energy distribution functions on the boundary lattice nodes via the treatment scheme of boundary condition for the lattice Boltzmann method;
S8. Repeating Steps S4-S7 until the end of liquid-vapor phase transition or a specified time.

According to the above steps, the total kinetic energy in the specific embodiment of the mesoscopic simulation method is thermodynamically defined as: The total kinetic energy ρeₖ is the sum of the internal kinetic energy ρòₖ and the macroscopic kinetic energy ½ρ|u|², i.e., ρeₖ=ρòₖ+½ρ|u|². The internal kinetic energy ρòₖ and the internal potential energy ρòₚ together constitute the internal energy ρò, i.e., ρò=ρòₖ+ρòₚ. The internal energy ρò and the macroscopic kinetic energy ½ρ|u|² together constitute the total energy ρe, i.e., ρe=ρò+½ρ|u|². Here, ρ is the density, u is the velocity, eₖ is the specific total kinetic energy, òₖ is the specific internal kinetic energy, òₚ is the specific internal potential energy, ò is the specific internal energy, and e is the specific total energy.

The total kinetic energy in the specific embodiment of the mesoscopic simulation method is interpreted at the mesoscopic level as: The physical interpretations at the mesoscopic level of the density ρ, velocity u, internal kinetic energy ρòₖ, and total kinetic energy ρeₖ are ρ=òƒ(x,ξ,t)dξ, ρu=òƒ(x,ξ,t)ξdξ,

$${ρò}_{k} = ò f ( x , ξ , t ) \frac{{\vert ξ - u \vert}^{2}}{2} d ξ , \\ and$$

$${ρ e}_{k} = ò f ( x , ξ , t ) \frac{{\vert ξ \vert}^{2}}{2} d ξ ,$$

respectively. Here, ƒ(x,ξ,t) is the continuum density distribution function described by the Boltzmann equation in kinetic theory, ξ is the molecular velocity, x is the position, and t is the time.

The internal kinetic energy in the specific embodiment of the mesoscopic simulation method satisfies: The internal kinetic energy ρòₖ relates to the temperature T by ρòₖ=ρcᵥT with cᵥ being the constant-volume specific heat.

The underlying physics of the internal potential energy in the specific embodiment of the mesoscopic simulation method is: The internal potential energy ρòₚ is the energy possessed by a molecule due to long-range attractive interaction from the other molecules.

The treatment method of the internal potential energy in the specific embodiment of the mesoscopic simulation method is: The transport process of the internal potential energy ρòₚ is represented by mimicking the work done by the long-range attractive intermolecular interaction.

The calculation method of the density, velocity, total kinetic energy, temperature, and pressure in the specific embodiment of the mesoscopic simulation method is: The density ρ and velocity u are calculated by the density distribution function, the total kinetic energy ρeₖ is calculated by the total kinetic energy distribution function, and the temperature and pressure are uniquely determined by ρ, u, and ρeₖ according to the thermodynamic relations.

The evolution equation in the specific embodiment of the mesoscopic simulation method satisfies: The lattice Boltzmann equation for density distribution function recovers the equation of state for dense gas and pairwise interaction force.

The evolution equation in the specific embodiment of the mesoscopic simulation method satisfies: The lattice Boltzmann equation for total kinetic energy distribution function recovers viscous dissipation, compression work, and works done by the pairwise interaction force and surface tension.

### Specific Embodiment

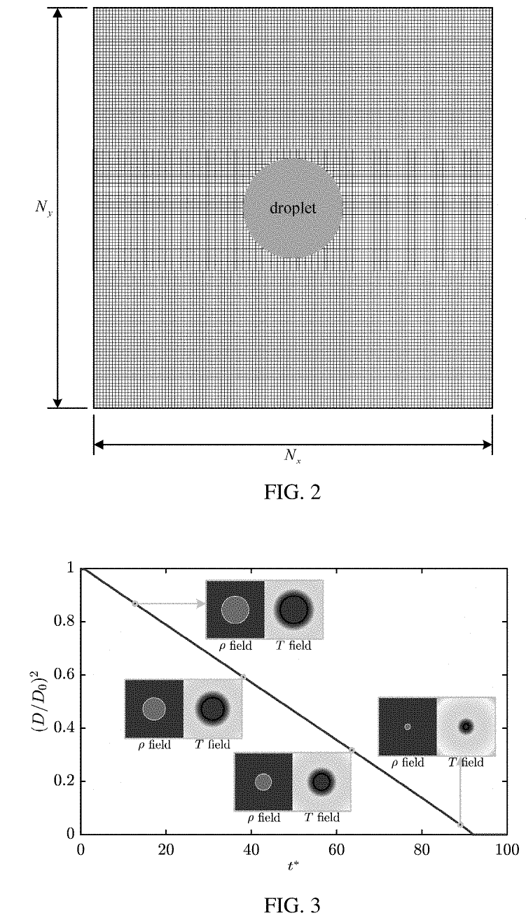

(1) The following specific embodiment of the mesoscopic simulation method considers the droplet evaporation in two-dimensional space shown in FIG. 2. The temporal evolutions of the droplet diameter and the density and temperature fields are simulated.

(2) The Carnahan-Starling equation of state is chosen

$${p}_{EOS} = {K}_{EOS} [ ρ RT \frac{1 + ϑ + {ϑ}^{2} - {ϑ}^{3}}{{( 1 - ϑ )}^{3}} - \tilde{a} {ρ}^{2} ] , \qquad Eq . ( 1 )$$

where ϑ=\tilde{b}ρ/4, ã=0.4963880577294099R²T_{cr}²/p_{cr}, \tilde{b}=0.1872945669467330RT_{cr}/p_{cr}, T_{cr} is the critical temperature, and p_{cr} is the critical pressure. The corresponding parameters are chosen as ã=1, \tilde{b}=4, and R=1. The initial temperature is set to T₀=0.8T_{cr}, which indicates that the saturated liquid and vapor densities are ρₗ=0.307195682 and ρ_{g}=0.0217232434, respectively. The surface tension and interface thickness are set to σ=0.01 and W=10, respectively, and thus the scaling factor is K_{EOS}=0.479820.

(3) For the two-dimensional situation, the standard D2Q9 discrete velocity set is adopted, and the nine discrete velocities are

$${e}_{i} = \{ \begin{matrix}{c ( 0 , 0 )}^{T} , & i = 0 , \\ {c ( cos [ ( i - 1 ) π / 2 ] , sin [ ( i - 1 ) π / 2 ] )}^{T} , & i = 1 , 2 , 3 , 4 , \\ \sqrt{2} {c ( cos [ ( 2 i - 1 ) π / 4 ] , sin [ ( 2 i - 1 ) π / 4 ] )}^{T} , & i = 5 , 6 , 7 , 8\end{matrix} , \qquad Eq . ( 2 )$$

where c=δₓ/δₜ is the lattice speed. The lattice spacing is set to δₓ=1, and the lattice sizes are Nₓ×N_{y}=1024×1024. The initial diameter of the droplet is D₀=256δₓ. The interaction strength is given by

G=K_{INT}\sqrt{2K_{EOS}ã/δₓ²}, Eq. (3)

and the lattice sound speed is chosen as

$${c}_{s} = {K}_{I N T} \sqrt{{( \frac{\partial {p}_{EOS}}{\partial ρ} )}_{T} + 2 {K}_{E O S} \tilde{a} ρ} {\vert}_{ρ = {ρ}_{l}} , \qquad Eq . ( 4 )$$

where the scaling factor K_{INT}=2.294922. The relation between the lattice speed and the lattice sound speed is c=\sqrt{3}cₛ, and thus the time step is δₜ=\sqrt{3}δₓ/(3cₛ). The constant-volume specific heat is set to cᵥ=0.005ρₗh_{fg}/[ρ_{g}(T₁−T₀)], where h_{fg} is the latent heat of vaporization and T₁=0.85T_{cr} is the heating temperature of all the four sides of the computation domain.

(4) The density on the lattice nodes is initialized as

$$ρ = \frac{{ρ}_{l} + {ρ}_{g}}{2} - \frac{{ρ}_{l} - {ρ}_{g}}{2} tanh \frac{\vert x - {x}_{c} \vert - {D}_{0} / 2}{W / ln ( 19 )} , \qquad Eq . ( 5 )$$

where x_{c}=(512δₓ,512δₓ)^{T} is the center of the computation domain. The velocity, temperature, and total kinetic energy on the lattice nodes are initialized as u=0, T=T₀, and ρeₖ=ρcᵥT+½ρ|u|², respectively, and the pressure on the lattice nodes is calculated based on the equation of state in Eq. (1). The pairwise interaction force is given by

Fₚₐᵢᵣ=G²ρ(x)Σᵢ₌₁⁸ω(|eᵢδₜ|²)ρ(x+eᵢδₜ)eᵢδₜ, Eq. (6)

where

$$ω ( {δ}_{x}^{2} ) = \frac{1}{3} and ω ( 2 {δ}_{x}^{2} ) = \frac{1}{12} .$$

The density distribution function ƒᵢ and the total kinetic energy distribution function gᵢ are initialized as

$${f}_{i} = {f}_{i}^{e q} - \frac{{δ}_{t}}{2} {F}_{v , i} , {g}_{i} = {g}_{i}^{e q} - \frac{{δ}_{t}}{2} {q}_{v , i} , \qquad Eq . ( 7 )$$

where ƒᵢ^{eq}=(M⁻¹m^{eq})ᵢ is the equilibrium density distribution function, F_{v,i}=(M⁻¹Fₘ)ᵢ is the discrete force term, gᵢ^{eq}=(M⁻¹n^{eq})ᵢ is the equilibrium total kinetic energy distribution function, and q_{v,i}=(M⁻¹qₘ)ᵢ is the discrete source term. Here, M is the orthogonal transformation matrix from velocity space to moment space

$$M = [ \begin{matrix}1 & 1 & 1 & 1 & 1 & 1 & 1 & 1 & 1 \\ - 4 & - 1 & - 1 & - 1 & - 1 & 2 & 2 & 2 & 2 \\ 4 & - 2 & - 2 & - 2 & - 2 & 1 & 1 & 1 & 1 \\ 0 & 1 & 0 & - 1 & 0 & 1 & - 1 & - 1 & 1 \\ 0 & - 2 & 0 & 2 & 0 & 1 & - 1 & - 1 & 1 \\ 0 & 0 & 1 & 0 & - 1 & 1 & 1 & - 1 & - 1 \\ 0 & 0 & - 2 & 0 & 2 & 1 & 1 & - 1 & - 1 \\ 0 & 1 & - 1 & 1 & - 1 & 0 & 0 & 0 & 0 \\ 0 & 0 & 0 & 0 & 0 & 1 & - 1 & 1 & - 1\end{matrix} ] , \qquad Eq . ( 8 )$$

m^{eq} is the equilibrium moment for the density distribution function

m^{eq}=[ρ, −2ρ+2η+3μ|û|², ρ+β₂η—3ρ|û|², ρûₓ, −ρuₓ, ρû_{y}, −ρû_{y}, ρûₓ²−ρû_{y}², ρûₓû_{y}]^{T}, Eq. (9)

Fₘ is the discrete force term in moment space

Fₘ=[0, 6\hat{F}·û, −6\hat{F}·û, \hat{F}ₓ, −\hat{F}ₓ, \hat{F}_{y},2\hat{F}ₓûₓ−2\hat{F}_{y}û_{y}, \hat{F}ₓû_{y}+\hat{F}_{y}ûₓ]^{T}, Eq. (10)

n^{eq} is the equilibrium moment for the total kinetic energy distribution function

n^{eq}=[ρeₖ, −4ρeₖ+(4+γ₁)C_{ref}T, 4ρeₖ−(4−γ₂)C_{ref}T, ρhₖûₓ, −ρhₖûₓ, ρhₖû_{y}, −ρhₖû_{y}, 0, 0]^{T}, Eq. (11)

and qₘ is the discrete source term in moment space

qₘ=[q, γ₁q, γ₂q, qûₓ, −qûₓ, qû_{y}, −qû_{y}, 0, 0]^{T}. Eq. (12)

Here, û=u/c, β₂=−2/(1−ω̅), \hat{F}=F/c, ρhₖ=ρeₖ+p_{LBE}, p_{LBE}=cₛ²(ρ+η), C_{ref} is the reference volumetric heat capacity, γ₁ and γ₂ are related to the heat conductivity, and ω̅ is related to the bulk viscosity. The built-in variable η in p_{LBE} is calculated by

$${p}_{E O S} = {p}_{L B E} - \frac{{G}^{2} {δ}_{x}^{2}}{2} {ρ}^{2} .$$

Without any external forces, the total force is F=Fₚₐᵢᵣ, and the work done by the total force is q=F·u.

(5) The local collision process of the lattice Boltzmann equation for density distribution function is performed in moment space as

m̅(x,t)=m+δₜFₘ−S(m−m^{eq}+δₜ/2Fₘ)+SQₘ, (13)

where m=M[ƒ₀, ƒ₁, . . . , ƒ₈]^{T} is the moment of the density distribution function, m̅(x,t) is the post-collision moment, S is the collision matrix in moment space

$$S = [ \begin{matrix}{s}_{0} & 0 & 0 & 0 & 0 & 0 & 0 & 0 & 0 \\ 0 & {s}_{e} & {ks}_{ɛ} ( {s}_{e} / 2 - 1 ) & 0 & h {\hat{u}}_{x} {s}_{q} ( {s}_{e} / 2 - 1 ) & 0 & h {\hat{u}}_{y} {s}_{q} ( {s}_{e} / 2 - 1 ) & 0 & 0 \\ 0 & 0 & {s}_{ɛ} & 0 & 0 & 0 & 0 & 0 & 0 \\ 0 & 0 & 0 & {s}_{j} & 0 & 0 & 0 & 0 & 0 \\ 0 & 0 & 0 & 0 & {s}_{q} & 0 & 0 & 0 & 0 \\ 0 & 0 & 0 & 0 & 0 & {s}_{j} & 0 & 0 & 0 \\ 0 & 0 & 0 & 0 & 0 & 0 & {s}_{q} & 0 & 0 \\ 0 & 0 & 0 & 0 & 2 b {\hat{u}}_{x} {s}_{q} ( {s}_{p} / 2 - 1 ) & 0 & - 2 b {\hat{u}}_{y} {s}_{q} ( {s}_{p} / 2 - 1 ) & {s}_{p} & 0 \\ 0 & 0 & 0 & 0 & b {\hat{u}}_{y} {s}_{q} ( {s}_{p} / 2 - 1 ) & 0 & b {\hat{u}}_{x} {s}_{q} ( {s}_{p} / 2 - 1 ) & 0 & {s}_{p}\end{matrix} ] , \qquad Eq . ( 14 )$$

and Qₘ is the source term to compensate for the third-order discrete lattice effect

$${Q}_{m} = \frac{{G}^{2} {δ}_{x}^{2} {δ}_{t}^{2}}{12} {[ 0 , 6 \vert ∇ ρ {\vert}^{2} , - 6 \vert ∇ ρ {\vert}^{2} , 0 , 0 , 0 , 0 , {( {\partial }_{x} ρ )}^{2} - {( {\partial }_{y} ρ )}^{2} , {\partial }_{x} ρ {\partial }_{y} ρ ]}^{T} . \qquad Eq . ( 15 )$$

Here, k=1−ω̅, h=6ω̅(1−ω̅)/(1−3ω̅), b=(1−ω̅)/(1−3ω̅), and the relaxation parameters satisfy

$$( {s}_{p}^{- 1} - \frac{1}{2} ) ( {s}_{q}^{- 1} - \frac{1}{2} ) = ( k + 1 ) ( {s}_{e}^{- 1} - \frac{1}{2} ) ( {s}_{q}^{- 1} - \frac{1}{2} ) = \frac{1}{12} .$$

The post-collision density distribution function is then obtained by ƒ̅ᵢ=(M⁻¹m̅)ᵢ.

The local collision process of the lattice Boltzmann equation for total kinetic energy distribution function is performed in moment space as

$$\overline{n} ( x , t ) = n + {δ}_{t} {q}_{m} - L ( n - {n}^{e q} + \frac{{δ}_{t}}{2} {q}_{m} ) + {c}^{2} Y ( \frac{m + \overline{m}}{2} - {m}^{e q} ) , \qquad Eq . ( 16 )$$

where n=M[g₀, g₁, . . . , g₈]^{T} is the moment of the total kinetic energy distribution function, n̅(x,t) is the post-collision moment, L is the collision matrix in moment space

$$\begin{matrix}Eq . ( 17 ) \\ L = [ \begin{matrix}{σ}_{0} & 0 & 0 & 0 & 0 & 0 & 0 & 0 & 0 \\ 0 & {σ}_{e} & 0 & 0 & 0 & 0 & 0 & 0 & 0 \\ 0 & 0 & {σ}_{ɛ} & 0 & 0 & 0 & 0 & 0 & 0 \\ 0 & 0 & 0 & {σ}_{j} & {σ}_{q} ( {σ}_{j} / 2 - 1 ) & 0 & 0 & 0 & 0 \\ 0 & 0 & 0 & 0 & {σ}_{q} & 0 & 0 & 0 & 0 \\ 0 & 0 & 0 & 0 & 0 & {σ}_{j} & {σ}_{q} ( {σ}_{j} / 2 - 1 ) & 0 & 0 \\ 0 & 0 & 0 & 0 & 0 & 0 & {σ}_{q} & 0 & 0 \\ 0 & 0 & 0 & 0 & 0 & 0 & 0 & {σ}_{p} & 0 \\ 0 & 0 & 0 & 0 & 0 & 0 & 0 & 0 & {σ}_{p}\end{matrix} ] ,\end{matrix}$$

Y is used to account for the viscous heat dissipation

$$Y = [ \begin{matrix}0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & {\hat{u}}_{x} / 3 & 0 & 0 & 0 & 0 & 0 & {\hat{u}}_{x} & 2 {\hat{u}}_{y} \\ 0 & - {\hat{u}}_{x} / 3 & 0 & 0 & 0 & 0 & 0 & - {\hat{u}}_{x} & - 2 {\hat{u}}_{y} \\ 0 & {\hat{u}}_{y} / 3 & 0 & 0 & 0 & 0 & 0 & - {\hat{u}}_{y} & 2 {\hat{u}}_{x} \\ 0 & - {\hat{u}}_{y} / 3 & 0 & 0 & 0 & 0 & 0 & {\hat{u}}_{y} & - 2 {\hat{u}}_{x} \\ 0 & 0 & 0 & 0 & 0 & 0 & 0 & 0 & 0 \\ 0 & 0 & 0 & 0 & 0 & 0 & 0 & 0 & 0\end{matrix} ] . \qquad Eq . ( 18 )$$

The post-collision total kinetic energy distribution function is then obtained by g̅ᵢ=(M⁻¹n̅)ᵢ.

(6) The linear streaming process of the lattice Boltzmann equation for density distribution function is performed in velocity space and the density distribution function at the next time step is obtained by

ƒᵢ(x+eᵢδₜ,t+δₜ)=ƒ̅ᵢ(x,t). Eq. (19)

The linear streaming process of the lattice Boltzmann equation for total kinetic energy distribution function is performed in velocity space and the total kinetic energy distribution function at the next time step is obtained by

gᵢ(x+eᵢδₜ,t+δₜ)=g̅ᵢ(x,t). Eq. (20)

(7) The density at the next time step is computed by

ρ(x,t+δₜ)=Σᵢ₌₀⁸ƒᵢ(x,t+δₜ). Eq. (21)

The pairwise interaction force Fₚₐᵢᵣ(x,t+δₜ) is then computed by Eq. (6). The velocity and specific total kinetic energy at the next time step are computed by

$$u ( x , t + {δ}_{t} ) = \frac{{\sum }_{i = 0}^{8} {e}_{i} {f}_{i} ( x , t + {δ}_{t} ) + \frac{{δ}_{t}}{2} F ( x , t + {δ}_{t} )}{ρ ( x , t + {δ}_{t} )} , \\ {e}_{k} ( x , t + {δ}_{t} ) = \frac{{\sum }_{i = 0}^{8} {g}_{i} ( x , t + {δ}_{t} ) + \frac{{δ}_{t}}{2} q ( x , t + {δ}_{t} )}{ρ ( x , t + {δ}_{t} )} . \qquad Eq . ( 22 )$$

The temperature at the next time step T(x,t+δₜ) is determined according to the relations ρeₖ=ρòₖ+½ρ|u|² and ρòₖ=ρcᵥT, and the pressure at the next time step p_{EOS}(x,t+δₜ is calculated based on the equation of state in Eq. (1).

(8) The boundary conditions on all the four sides of the computation domain in FIG. 2 are outflow, constant-pressure, and constant-temperature conditions. Accordingly, the density, velocity, total kinetic energy, temperature, and pressure on the boundary lattice nodes can be determined. The density and total kinetic energy distribution functions on the boundary lattice nodes are then constructed via the treatment scheme of boundary condition for the lattice Boltzmann method.

(9) Repeat (5)˜(8) until the normalized time t*=α_{g}t/D₀² reaches 100. Here, α_{g} is the thermal diffusivity of the gas phase.

(10) FIG. 3 shows the evolution of the square of the normalized droplet diameter (D/D₀)² with the normalized time t*, together with four snapshots of the local density and temperature fields in the vicinity of the droplet. It can be seen from FIG. 3 that liquid-vapor phase transition is successfully captured by the mesoscopic simulation method. Moreover, the evaporation process perfectly obeys the D²-law. These results demonstrate the applicability and accuracy of the mesoscopic simulation method for liquid-vapor phase transition.

The above is only a specific embodiment of the mesoscopic simulation method for liquid-vapor phase transition in the two-dimensional situation. It should be pointed out that for those skilled in the art, several modifications, substitutions, and improvements can be made. However, without departing from the spirit and principle of the claims, any modifications, substitutions, and improvements still belong to the scope of the claims.

What is claimed is:

1. A mesoscopic simulation method for liquid-vapor phase transition: Short-range repulsive intermolecular interaction is incorporated by equation of state for dense gas, long-range attractive intermolecular interaction is mimicked by pairwise interaction force, density distribution function is used to handle mass-momentum conservation laws, and total kinetic energy distribution function is used to handle energy conservation law. The mesoscopic simulation method comprises the following steps:
S1. Choosing the equation of state for real gases and corresponding parameters, setting the initial temperature, determining the saturated liquid and vapor densities, setting the surface tension and interface thickness;
S2. Setting the lattice spacing and lattice sizes, computing the interaction strength, lattice sound speed, time step, and constant-volume specific heat;
S3. Initializing the density, velocity, total kinetic energy, temperature, and pressure on the lattice nodes, computing the pairwise interaction force based on the density field, initializing the density and total kinetic energy distribution functions;
S4. Performing the local collision process of the lattice Boltzmann equation for density distribution function and then getting the post-collision density distribution function, performing the local collision process of the lattice Boltzmann equation for total kinetic energy distribution function and then getting the post-collision total kinetic energy distribution function;
S5. Performing the linear streaming process of the lattice Boltzmann equation for density distribution function and then getting the density distribution function at the next time step, performing the linear streaming process of the lattice Boltzmann equation for total kinetic energy distribution function and then getting the total kinetic energy distribution function at the next time step;
S6. Computing the density at the next time step, updating the pairwise interaction force based on the density field, computing the velocity, total kinetic energy, temperature, and pressure at the next time step;
S7. Determining the density, velocity, total kinetic energy, temperature, and pressure on the boundary lattice nodes based on specified boundary conditions, constructing the density and total kinetic energy distribution functions on the boundary lattice nodes via the treatment scheme of boundary condition for the lattice Boltzmann method;
S8. Repeating Steps S4-S7 until the end of liquid-vapor phase transition or a specified time.

2. The mesoscopic simulation method of claim 1 wherein the total kinetic energy ρeₖ is thermodynamically defined as the sum of the internal kinetic energy ρòₖ k and the macroscopic kinetic energy ½ρ|u|², i.e., ρeₖ=ρòₖ+½ρ|u|²; the internal kinetic energy ρòₖ and the internal potential energy ρòₚ together constitute the internal energy ρò, i.e., ρòₖ=ρòₖ+ρòₚ; the internal energy ρòₖ and the macroscopic kinetic energy ½ρ|u|² together constitute the total energy ρe, i.e., ρe=ρò+½ρ|u|². Here, ρ is the density, u is the velocity, eₖ is the specific total kinetic energy, òₖ is the specific internal kinetic energy, òₚ is the specific internal potential energy, ò is the specific internal energy, and e is the specific total energy.

3. The mesoscopic simulation method of claim 2 wherein the physical interpretations at the mesoscopic level of the density ρ, velocity u, internal kinetic energy ρòₖ, and total kinetic energy ρeₖ are ρ=òƒ(x,ξ,t)dξ, ρu=òƒ(x,ξ,t)ξdξ,
$$ρ {{o}^{`}}_{k} = ò f ( x , ξ , t ) \frac{{\vert ξ - u \vert}^{2}}{2} dξ , and ρ {e}_{k} = ò f ( x , ξ , t ) \frac{{\vert ξ \vert}^{2}}{2} dξ ,$$
respectively Here, ƒ(x,ξ,t) is the continuum density distribution function described by the Boltzmann equation in kinetic theory, ξ is the molecular velocity, x is the position, and t is the time.

4. The mesoscopic simulation method of claim 3 wherein the internal kinetic energy ρòₖ relates to the temperature T by ρòₖ=ρcᵥT with cᵥ being the constant-volume specific heat.

5. The mesoscopic simulation method of claim 2 wherein the internal potential energy ρòₚ is the energy possessed by a molecule due to long-range attractive interaction from the other molecules.

6. The mesoscopic simulation method of claim 5 wherein the transport process of the internal potential energy ρòₚ is represented by mimicking the work done by the long-range attractive intermolecular interaction.

7. The mesoscopic simulation method of claim 1 wherein in Step S6, the density ρ and velocity u are calculated by the density distribution function, the total kinetic energy ρeₖ is calculated by the total kinetic energy distribution function, and the temperature and pressure are uniquely determined by ρ, u, and ρeₖ according to the thermodynamic relations.

8. The mesoscopic simulation method of claim 1 wherein the lattice Boltzmann equation for density distribution function recovers the equation of state for dense gas and pairwise interaction force.

9. The mesoscopic simulation method of claim 1 wherein the lattice Boltzmann equation for total kinetic energy distribution function recovers viscous dissipation, compression work, and works done by the pairwise interaction force and surface tension.
